(19) United States
(12) Patent Application Publication
(10) Pub. No.: US 2006/0155043 A1
(43) Pub. Date: Jul. 13, 2006

(54) Nanostructure composites

(75) Inventors: Alan T. Johnson, Philadelphia, PA (US); Karen I Winey, Philadelphia, PA (US); Gennaro J Gama, Athens, GA (US); Michael J Biercuk, Cambridge, MA (US); James Hone, New York, NY (US); Reto Haggenmueller, Philadelphia, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: The Trustees of the University of Pennsylvania, Philadelphia, PA (US)

(21) Appl. No.: 10/507,879

(22) PCT Filed: Mar. 20, 2003
(86) PCT No.: PCT/US03/08816

§ 371 Date: Aug. 17, 2005

Related U.S. Application Data
(60) Provisional application No. 60/366,146, filed on Mar. 20, 2002.
(60) Provisional application No. 60/390,302, filed on Jun. 20, 2002.
(60) Provisional application No. 60/390,303, filed on Jun. 20, 2002.

(51) Int. Cl. C08K 3/04

(52) U.S. Cl. 524/495

(57) ABSTRACT

Compositions comprising a highly dispersed mixture of nanostructures and polymeric materials in a solvent or suspension medium, composites made therefrom having enhanced mechanical, thermal and electronic properties, and methods for making such composites are provided.

### CROSS REFERENCE TO RELATED APPLICATION

This claims the benefit of and incorporates by reference provisional Application No. 60/366,146, filed Mar. 20, 2002, and provisional Application Nos. 60/390,302 and 60/390,303, both filed on Jun. 20, 2002.

### STATEMENT OF GOVERNMENT INTEREST

The U.S. Government may have a paid-up license in this invention and the right in limited circumstances to require the patent owner to license others on reasonable terms as provided for by the terms of one or more research grants awarded by the Office of Naval Research.

### FIELD OF THE INVENTION

The present invention is directed to composites comprising nanostructures and polymeric materials. These composites have enhanced thermal and electronic properties and increased mechanical strength. The invention is directed also to methods for making such nanostructure composites.

### BACKGROUND OF THE INVENTION

Polymeric materials have many advantageous processing and performance properties and are useful in innumerable applications. For certain applications, thermal or electrical conductivity and/or mechanical strength may be required or desirable. While such properties are found in certain specialty polymers, such polymers are expensive and difficult to manufacture. As a result, the use of such polymers in such applications have thus far been limited.

In order to enhance the inherent performance characteristics of polymeric materials, it has been recognized that fillers may be used. Fillers have their own set of inherent properties which, when combined with a polymeric material to form a composite, impart aspects of these properties to the composite. Fillers may be used with commodity polymeric material to enable the composites formed therefrom to be used in applications which require thermal or electrical conductivity and/or mechanical strength not found in the neat form of the polymeric material. Fillers may also be used with specialty polymers in order to further enhance their particular properties. Ideally, these composites maintain all of the advantageous properties of the neat polymeric material while also taking on additional properties imparted by the filler. In practice, however, attempts at enhanced composites often require a trade-off between desired performance, mechanical properties, cost, and ease of processing.

Polymeric composites can be formed from mixtures of polymeric materials and high thermal conductivity particle fillers. In such composites, particle fillers such as alumina, metal powders, and boron nitride are added to materials such as silicone rubber, polyamide, and polyester in loading amounts of typically about 50% or even higher. The resulting composites have thermal conductivities on the order of 5 W/m-K.

Nanostructures, such as single-wall carbon nanotubes (SWNTs), are extremely promising for enhancing the properties of polymeric materials and represent a significant shift from conventional fillers for polymer composites. In contrast to conventional composites, where filler dimensions are on the order of microns, nanostructures are characteristic for discrete constituents on the nanometer scale. As phonons dominate thermal transport in nanostructure materials across all temperatures, nanostructures appear particularly advantageous for high-performance thermal management. Depending on materials of construction, nanostructures can also exhibit electronic conductivity and resistivity, as well as a high Young's modulus and strength-to-weight ratio. The combination of these physical, thermal and electronic properties yields a filler that is particularly advantageous in imparting such properties to polymeric materials with which they are combined.

Despite this great promise, progress in using nanostructures in composites has proved difficult. Nanotube-epoxy composites previously manufactured have typically been weaker or only slightly stronger than pristine epoxy (Vaccarini et al. Proceedings of the XIV International Winterschool, p. 521; 2000; Ajayan et al. Advanced Materials 12, p. 750; 2000; and Schadler et al. Appl. Phys. Lett., 73, p. 3842; 1998). Enhanced strength has been observed in SWNT-PMMA composites (Haggenmueller et al. Chem. Phys. Lett. 330, p. 219; 2000), however the composites did not display the levels of strength and thermal conductivity associated with bulk nanostructures.

The development of the high-pressure carbon monoxide (HiPCO) process for fabricating nanostructures allows production of 1 gram/hour of SWNTs, inviting nanostructure applications requiring industrial quantities. Despite the capability to produce suitable amounts of nanostructures for industrial applications, there remains a need for polymeric composites incorporating nanostructures and methods for making such composites which can more fully exploit the unique mechanical, thermal and electronic properties of bulk nanostructures.

### SUMMARY OF THE INVENTION

According to one aspect of the present invention, there is provided a composition comprising a highly dispersed mixture of a polymeric material and nanostructures wherein the nanostructures comprise from about 0.01 to about 50.0 percent by weight of the solids in the mixture and are dispersed throughout the mixture. The polymeric material is in solid form such as powders or pellets, or in liquid form, and the nanostructures have an average size between about 0.5 nm and about 50 nm in diameter and between about 0.5 nm and about 10 microns in length. The mixture may be in the form of either a solution or a suspension, and the dispersion of the polymeric material and the nanostructures in the solvent or suspension medium may be achieved with the assistance of, for example, sonication, agitation, surfactants and/or surface functionalization of the nanostructures. In preferred embodiments, the solution or suspension of the polymeric material and the nanostructures is degassed under reduced air pressure.

According to another aspect of the present invention, there is provided a composite comprising a highly dispersed mixture of uncured polymeric material and nanostructures wherein the nanostructures comprise from about 0.01 to about 50.0 percent by weight of the composite and are dispersed throughout the polymeric material. This composite may be formed from the solution or suspension of the present invention by separation of the solids from the solvent or the suspension medium. Separation of the solids from the solvent or the suspension medium may be accomplished by various methods including, for example, evaporation or filtration under either ambient or modified pressure.

According to another aspect of the present invention, there is provided a composite comprising a highly dispersed mixture of a cured polymeric material and nanostructures in which the nanostructures are incorporated and dispersed in the uncured form of the polymeric material in solution or suspension and comprise from about 0.01 to about 50.0 percent by weight of the composite and are dispersed throughout the cured polymeric material. The cured composition may be made from the uncured composite of the present invention and may be cured by various methods including, for example, the addition of a curing agent or a catalyst and/or the application of heat and/or electromagnetic radiation such as UV light.

According to yet another aspect of the present invention, there is provided a polymer composite kit comprising a first amount of the uncured composite of the present invention and a second amount of a curing agent sufficient to cure the first amount of the uncured composite upon combination therewith. The kit may further comprise additional items such as dispensers, tools useful in curing the composite, and materials designed for use with the cured composite.

According to a further aspect of the present invention, there is provided a method for making a composition comprising the step of combining a polymeric material and nanostructures in a liquid medium to form a highly dispersed mixture. The mixture formed by this method may be in the form of a solution or a suspension. In either embodiment, the nanostructures preferably comprise from about 0.01 to about 50.0 percent by weight of the total solids of the mixture. The high degree of dispersion may be achieved with the assistance of sonication, agitation, surfactants and/or surface functionalization of the nanostructures. This method may optionally include the subsequent step of degassing the solution or suspension under reduced air pressure.

According to yet another aspect of the present invention, there is provided a method for making an uncured composite from a highly dispersed solution or a suspension of polymeric material and nanostructures comprising the step of separating the polymeric material and nanostructures from the solution or suspension. Separation of the solids from the solvent or the suspension medium may be accomplished by various methods including evaporation or filtration under either ambient or modified pressure.

There is further provided a method for making a cured composite from an uncured composite comprising a highly dispersed mixture of polymeric material and nanostructures comprising the step of curing the uncured composite. The curing of the uncured composite may be accomplished by, for example, the addition of a curing agent or a catalyst and/or the application of heat and/or electromagnetic radiation such as UV light.

The highly dispersed network of nanostructures in the polymeric materials of the present invention contribute to the enhancement of mechanical, thermal and electronic properties of composites and materials made therefrom, and allow such composites to be well-suited for use in a wide variety of demanding applications in the power, electronics, transportation, defense and aerospace industries including thermal management for power generation systems, heat pump radiators, air and space platforms, long-life space cryocoolers, weapons systems, ground and marine vehicles, specialty materials, field emission displays, laser diodes, diode fibers, slab lasers and associated electronics including high power density wide bandgap devices.

### BRIEF DESCRIPTION OF THE DRAWINGS

FIG. 1 is a scanning electron micrograph of 1.0 weight percent SWNTs in an epoxy composite according to the present invention.

FIG. 2 is a graph of thermal conductivity of a composite as a function of percent weight loading of carbon material.

FIG. 3 is a graph of thermal conductivity data for epoxy without carbon material, a SWNT-epoxy composite and a composite made from of epoxy and vapor grown carbon fibers.

### DETAILED DESCRIPTION OF THE INVENTION

The present invention is directed to compositions of highly dispersed polymeric materials and nanostructures, kits comprising curable forms of such materials, and methods for making such materials. The composites described herein are capable of being formed into materials and products which demonstrate enhanced thermal and electrical conductivity and increased mechanical strength as compared to the neat form of the polymeric materials used therein.

One aspect of the present invention is a composition in the form of a highly dispersed mixture comprising a polymeric material and nanostructures in which the nanostructures comprise from about 0.01 to about 50.0 percent by weight of the mixture. The mixture may be in the form of a nanostructure solution, a nanostructure suspension, or a combination thereof. As used herein, a solution comprises a mixture in which the polymeric material and the nanostructures are either partially or completely solvated, and a suspension comprises a dispersion of the polymeric material and the nanostructures in a suspension medium. Whether in the form of a solution or suspension, the mixture of the polymeric material and the nanostructures, collectively referred to herein as solids, is substantially homogeneous.

In embodiments in which the mixture is in the form of a solution, the solution may be formed by the combination of the nanostructures with a solution of the polymeric material, by the combination of the polymeric material with a nanostructure solution, or by the combination of the polymeric material and the nanostructures together with the solvent. Additionally, the solvent may be formed by first forming a suspension of the polymeric material and the nanostructures and further processing the suspension to form a solution such as, for example, by heating, dilution, or other appropriate treatment.

Nanostructures that are considered suitable for use in the composition of the present invention are nanostructures capable of forming a highly dispersed mixture with a polymeric material in a solution or a suspension. Two such suitable forms of nanostructures are single-wall nanotubes (SWNTs) composed of a single molecular sheet in the form of a cylinder, and multi-wall nanotubes (MWNTs) which consist of multiple molecular sheet in the form of coaxially disposed cylinders. Suitable nanostructures include also bundles of SWNTs or MWNTs. As used herein, the term nanotubes (NTs) may refer to individual SWNTS, SWNT bundles, individual MWNTs, MWNT bundles, and combinations thereof.

In preferred embodiments, the molecular sheets forming the SWNTs or MWNTs comprise carbon and, in sheet form, are referred to as graphene. In addition to carbon, NTs may also be formed from other elements and compounds such as, for example, carbon nitride, boron, boron nitride, molybdenum disulfide and tungsten disulfide, and NTs formed from any of the foregoing materials are considered within the scope of this invention. Other nanostructure materials such as nanorods and hollow nanocylinders made from boron nitride, CaO, MgO, ZnO, Si, SiC, and InAs, having solubility properties similar to carbon SWNTs and MWNTs, are also considered suitable for use in this invention.

In addition to the foregoing, other suitable nanostructures include nanowires and C₆₀ encapsulating nanotubes. Nanowires are nanotubes that contain conducting or semiconducting material such as, for example, Si, GaAs, or GaN particles. These elements are incorporated into the nanotube interior to form a nanowire such as, for example, a Si nanowire, a GaAs nanowire or a GaN nanowire. C₆₀ encapsulating nanotubes are NTs which contain C₆₀ structures, also called Buckyballs, and are referred to as “peapods” because the Buckyballs resemble peas in a nanotube pod. Peapods are also capable of forming a coaxial tube structure, also known as a double-wall nanotube (DWNT), by the merging together of the C₆₀ molecules inside the encapsulating nanotube. These nanostructures are described in Smith et al., Nature 396 p. 323-324, 1998; Smith et al., Chem. Phys. Lett. 315 p. 31-36, 1999; Huang et al., Science 291 p. 630-633; and Sloan et al., Chem. Phys. Lett. 316 p. 191-198, 2000.

Suitable nanostructures are preferably less than about 1000 nm in diameter. In preferred form, SWNTs and MWNTs have an average size between about 0.5 and about 5 nm in diameter. When nanotubes form bundles, the bundles preferably have an average diameter between about 3 nm and about 50 nm. Regardless of bundle size, however, the nanostructures preferably have an aspect ratio greater than about 100, and preferably in the range of about 5,000 to about 10,000 or greater. Aspect ratios in this range permit the formation of random networks of nanostructures that impart enhanced thermal conductivity throughout the polymeric material even at low loading levels.

Depending on the method by which nanostructures are made, varying amounts of materials other than nanostructures may be present. Such materials may include various forms of carbon that are reactants or byproducts of the nanostructure fabrication process. Where the amount of carbon and other materials other than nanostructures are present in significant amounts, such material is referred to a having a low purity. By contrast, nanostructure material comprised substantially of SWNTs that contains small amounts of other types of carbon or other materials is referred to as having a high purity. Highly pure nanostructure material comprises at least about 95% SWNTs and is difficult to manufacture. Nanostructure material of lower purity may have from about 50 to about 80% SWNTs and is associated with less complicated and expensive fabrication methods. As a result of the high degree of nanostructure dispersion achieved by the compositions of the present invention, the degree of percolation necessary to impart enhanced mechanical, thermal and electronic properties to composites made from such compositions may be achieved at much lower loading levels as compared with conventional fillers. Such loading levels may be accomplished by the use of a small amount of high purity nanostructure material or a larger amount of lower purity nanostructure material. For example, if the target SWNT loading was set at about 0.4% w/w, equivalent SWNT loadings may be accomplished by the use of either 0.4% w/w of a highly pure nanostructure material or 0.8% w/w of 50% pure nanostructure material. In most applications, the nanostructures comprise from about 0.01 to about 50.0 percent by weight of the mixture. In preferred embodiments, the nanostructures comprise from about 0.1 to about 50.0 percent by weight of the mixture, and even more preferably form about 0.1 to about 10.0 percent by weight of the mixture. Preferably, the nanostructures are randomly oriented in the mixture.

The physical and chemical properties of nanostructures are influenced by two main geometric parameters: (1) symmetry, which affects electronic and thermal properties; and (2) aspect ratio, defined as the ratio between length and cross-section diameter, which affects thermal and mechanical properties. The symmetry of nanostructures and their electronic characteristics are modulated by a number of factors including alterations in tube radius such as, for example, by controlling the number of C₆ motifs present along the circumference of the NTs. Conductive and semiconductive carbon NTs (CNTs) can thus be produced. Boron nitride nanotubes (BNNTs), on the other hand, are thermally conductive but electronically insulative, and thus polymer composites in which BNNTs are dispersed throughout can act as electronic insulators that are capable of exhibiting enhanced thermal conductivity.

Both CNTs and BNNTs exhibit extremely high thermal conductivity. According to theory, CNTs have the largest thermal conductivity of any known molecular material. By comparison, while diamond has a thermal conductivity of 2320 W/mk, single-wall CNTs (SWCNTs) are predicted to exhibit a room temperature thermal conductivity value of about 6,000 W/mk. Measurements of individual MWNTs have shown a room temperature thermal conductivity value of about 3,000 W/mk. Superior thermal properties of NTs are attributed to phonon confinement in their structure.

Solvents and suspension media which are suitable for use in the present invention are liquid phase materials capable of solvating or suspending highly dispersed mixtures of nanostructures and polymeric material. Preferably, the liquid phase material is an organic material such as, for example, dichloroethane, N,N-dimethylformamide (DMF), N-methylpyrrolidone (NMP), ethanol and isopropanol. Preferably, the liquid phase material is volatile.

The polymeric material of the nanostructure mixture of the present invention may be any polymeric material which is suitable for combination with nanostructures and capable of forming a highly dispersed solution or suspension therewith. As used herein, the term polymeric materials include monomers, oligomers, prepolymers, polymers, copolymers and combinations thereof. Polymer classes and particular polymers that are suitable for use in the compositions of the present invention include thermoplastics such as polyesters, polyolefins such as polyethylene, vinyl polymers such as polystyrene, poly(methyl methacrylate), polypropylene sulfide and polypropylene oxide; thermosetting materials such as elastomers and epoxies including bisphenol F; silicone; and polyamides such as poly(m-phenylene isophthalamide) and poly(p-phenylene isophthalamide) sold under the trade names Nomex® and Kevlar®, respectively. Such polymeric materials may be used either singly or in combination.

In those embodiments in which the polymeric material of the composition comprises an aromatic polyamide such as poly(m-phenylene isophthalamide) and poly(p-phenylene isophthalamide), low loading levels of nanostructure materials in the composition of the present invention allows for minimal disturbance of the extensive, three-dimensional network of hydrogen bonds associated with the mechanical strength of such polymeric materials. Further, in view of the mechanical strength of the nanostructures themselves, the inherent properties of both the aromatic polyamide and the nanostructure material can act cooperatively in enhancing the mechanical strength of composites made therefrom. The mechanical strength of the aromatic polyamide material further allows for either lower loading of nanostructure material or the use of nanostructure material of lower purity without substantial loss of mechanical properties.

In those embodiments in which electronic conductivity is of particular importance, preferred polymers include electronically conductive polymers such as polyethylene-dioxythiophene (PDOT), polyaniline, polypyrrole, polythiophenes, and poly(p-phenylene vinylene)s. In such embodiments, the electronic conductivity inherent in the polymeric material is significantly enhanced by the highly dispersed network of nanostructures even at low nanostructure loading levels.

In most applications, the polymeric material component of the compositions of the present invention comprises from about 5 to about 99.99, and preferably from about 50 to about 99.9, percent of the total solids content of the composition. Embodiments which utilize either high-strength polymers or electrically conductive polymers have the added advantage of permitting lower nanostructure loadings as compared with commodity polymeric material not exhibiting such properties. The decrease in strength or electrical conductivity associated with a lower nanostructure load is compensated for by either the inherent strength or conductivity of such polymeric material.

In preferred embodiments, additional materials may be added to the compositions of the present invention in order to further modify the properties of composites made therefrom. Such additives may include, for example, silica; boron nitride; metal particles such as silver, gold and alumina; and forms of carbon such as graphite, carbon fibers, and carbon black. These additives may be provided separately as a distinct component of the composition or, in the case of nanostructures of low purity, together as a part of the nanostructure material. As such, materials such as graphite, carbon fibers, carbon black and other materials present in the nanostructure material may be regarded as additives within the scope of the present invention. Where additives are used, it is preferred that such additives comprise from about 0.01 to about 85 percent of the total solids content of the composition.

In those embodiments of the composition of the present invention in which an epoxy is used as the polymeric material, a preferred additive is silica. Composite materials made from such compositions such as, for example, encapsulated integrated circuit (IC) devices, exhibit a reduced thermal expansion coefficient and improved thermal conductivity. Where silica is used as an additive in a nanocomposite/epoxy composition, it is preferred that the silica comprise from about 10 to about 90 percent, and preferably from about 60 to about 85 percent, of the total solids content of the composition.

Depending on the particular properties of the solvent or suspension medium used, and the quantity, type and purity of nanostructure material, the dispersal of the nanostructures may require extensive mixing which may be aided by sonication, including ultrasonication, and/or the use of surfactants and/or surface functionalization of the nanostructures. Sonication involves mixing the polymeric material and nanostructures in a liquid phase material and placing the mixture in a bath sonicator. Sonication can assist in breaking up bundles of nanostructure materials into individual nanotubes and smaller bundles. For example, a concentration of less than about 0.1 mg/ml of nanostructures may be sonicated for about 6 to about 8 hours. Depending on the nature and quantity of the nanostructures and the liquid medium that are used, sonication can produce either a solution or a suspension of nanostructure materials. Preferably, the nanostructure concentration is between about 0.01 mg/ml and about 100 mg/ml.

Surfactants mediate interactions by effectively lowering the interfacial free energy. Furthermore, surfactants may serve to catalyze interfacial interactions, initiate polymerizations, or serve as anchoring points for the polymeric material and thereby improve the strength of the interface between the polymeric material and the nanostructures. Surface functionalization of the nanostructures may also contribute to the dispersal of the nanostructures throughout the polymeric material. For example, polymer-bound carbon nanotubes can be formed by covalently attaching nanotubes to highly soluble linear polymers such as poly(propionethylenimine-co-ethylenimine) (PPEI-EI) via amide linkages or poly(vinyl acetate-co-vinyl alcohol) (PVA-VA) via ester linkages (Riggs, J. E.; Guo, Z.; Carroll, D. L.; Sun, Y. P., J. Am. Chem. B. 2000, 122, 5879).

The formation of the composition of the present invention by the combination of nanostructures with a polymeric material in the solvent or suspension medium produces a uniform distribution of the nanostructures which can be indicated by a transition from a lumpy mixture to a smooth emulsion. The final structure of the composition results from the transformation of an initially microscopically heterogeneous system to a nanoscopically homogenous system.

In order to further enhance the physical properties to the composition, the composition may be degassed. The removal of gases from the composition reduces the number of voids within the composite. Voids in the form of gas bubbles interfere with the thermal and electronic conductivity of the composite and create weak points which adversely affect the mechanical strength of the composite. Degassing may occur under reduced air pressure, at elevated temperature, under flowing gas, through settlement at ambient air pressure, or combinations of these conditions. Preferably, degassing of the composition is accomplished by subjecting the mixture to an atmosphere from ambient pressure to about 10⁻⁶ Torr for a period of about 1 hour to about 7 days.

According to another aspect of the present invention, there is provided a composite comprising a highly dispersed mixture of an uncured polymeric material and nanostructures wherein the nanostructures comprise from about 0.01 to about 50.0 percent by weight of the composite. This composite may be formed from the solution or suspension of the present invention by separation of the solids from the solvent or the suspension medium. Separation of the solids from the solvent or the suspension medium may be accomplished by various methods including the application of heat, or evaporation and/or filtration under either ambient or modified pressure. In a preferred embodiment, separation is achieved by heating the composition to between 100° C. and 190° C. Preferably, the mass of the composite after the solvent or suspension medium is removed will be within less than 0.5% of the mass of the nanostructures and the polymeric material, and the nanostructures are randomly oriented in the composite. The uncured composite of the present invention exhibits enhanced mechanical, thermal and electronic properties as a result of the highly dispersed network of nanostructures throughout the polymeric material.

According to another aspect of the present invention, there is provided a composite comprising a highly dispersed mixture of a cured polymeric material and nanostructures in which the nanostructures are incorporated and dispersed in the uncured form of the polymeric material in solution or suspension and comprise from about 0.01 to about 50.0 percent by weight of the composite. The cured composition may be made from the uncured composite of the present invention and may be cured by various methods including the addition of a curing agent or catalyst and/or the application of heat and/or electromagnetic radiation such as UV light. In those embodiments in which a curing agent is used, the type and amount of curing agent selected will vary in accordance with the polymeric material used and the processing steps by which curing is to be effected.

According to a further aspect of the present invention, there is provided a polymer composite kit comprising a first amount of an uncured composite comprising a highly dispersed mixture of an uncured polymeric material and nanostructures wherein the nanostructures comprise from about 0.01 to about 50.0 percent by weight of the composite, and a second amount of a curing agent. The second amount of the curing agent included in the kit is selected to be sufficient to cure the first amount of the uncured composite when combined together. The kit may further comprise additional items such as dispensers, tools useful in curing the composite, and materials designed for use with the cured composite.

According to a further aspect of the present invention, there is provided a method for making a composition comprising the step of combining a polymeric material and nanostructures in a liquid medium to form a highly dispersed mixture. The mixture formed by this method may be in the form of a solution or a suspension. In either embodiment, the nanostructures are preferably combined in amounts about 0.01 to about 50.0 percent by weight of the total solids of the mixture. The high degree of dispersion achieved by the method of the present invention may be accomplished with the assistance of sonication, agitation, surfactants and/or surface functionalization as described above.

This method may optionally include the subsequent step of degassing the solution or suspension of polymeric material and nanostructures under reduced air pressure. In such embodiments, the mixture is subjected to an air pressure of from ambient pressure to about 10⁻⁶ Torr for a period of about 1 hour to about 7 days.

According to yet another aspect of the present invention, there is provided a method for making a composite from a highly dispersed solution or suspension of polymeric material and nanostructures comprising the step of separating the polymeric material and nanostructures from the solution or suspension. Separation of the solids from the solvent or the suspension medium may be accomplished by various methods including evaporation or filtration under either ambient or modified pressure. Preferably, separation is accomplished by application of heat at ambient pressure. In such embodiments, the mixture is exposed to a temperature from ambient temperature to about the boiling point of the solvent or suspension medium used for a period sufficient to remove substantially all of the solvent or suspension medium from the solids.

According to a further aspect of the present invention, there is provided a method for making a cured composite from an uncured composite comprising a highly dispersed mixture of polymeric material and nanostructures comprising the step of curing the uncured composite. The curing of the uncured composite may be accomplished by, for example, the addition of a curing agent or a catalyst and/or the application of heat and/or electromagnetic radiation such as UV light as discussed above.

Thermal transport, electrical conductivity and Vickers hardness data for selected composite materials of the invention are set forth below in the Examples. It is believed that the superior mechanical and physical properties of the composite materials of the present invention are related to the level of dispersion of the nanostructures

The composites and methods of making such composites of the present invention are illustrated by the following examples and is not intended to be limited thereby.

### EXAMPLES

Composite materials utilizing Shell Chemicals Epon 862 epoxy resin as the polymeric resin and Air Products Ancamine 2435 dimethane-amine as a curing agent were prepared as described below. Example 1 sets forth a composite material loaded with raw SWNT soot grown by a high pressure carbon monoxide (HiPCO) method in accordance with one embodiment of the present invention. Comparative Example 1 sets forth a composite material comprising vapor grown carbon fibers (VGCF) from Applied Sciences, Inc. An example of a pristine epoxy material without a carbon additive is provided by the 0.0 weight percent loading samples of the examples.

### Example 1

A composite material comprising SWNT structures was formed by dispersing the SWNT structures in an organic solvent. The SWNT structures contained approximately 15-25 wt % Fe catalyst in the form of isolated nanoparticles. The weight percent loading values of the SWNT structures set forth below and in the figures are based on the mass of as-grown SWNT material and are not reduced to account for the Fe impurities. Transmission electron microscopy revealed that the SWNT structures had a broad distribution in tube diameter. This distribution peaked at 1.1 nm in diameter with tube lengths from hundreds of nanometers to several microns. The nanotube bundles were small in diameter (3-30 nm). Neutron diffraction indicated poor bundle crystallinity.

In dispersing the SWNT structures in the solvent, particular care was taken to disperse the SWNT structures uniformly. SWNT structures were dispersed ultrasonically for as long as 48 hours in either dichloroethane or N-N dimethylformamide to promote the formation of a stable suspension.

The epoxy resin was subsequently dissolved in the nanotube-solvent mixture. The weight percent of the nanotube component varied from 0.0% to 5.0%. The transition from a lumpy mixture to a smooth emulsion indicated uniform distribution of the carbon material. The nanotube-resin solution was then placed under vacuum to remove trapped air. After degassing, the samples were placed on a hot plate at 130° C. for about 1 hour to completely evaporate the solvent. The Ancamine 2435 dimethane-amine was then added as a curing agent, and samples of the composite was cured at room temperature for two to four days followed by a post-cure bake at 120° C. for two hours.

### Comparative Example 1

Composite materials were prepared according to the method of Example 1, except that the carbon materials used were vapor grown carbon fibers instead of SWNTs. Pyrograf-III vapor grown carbon fibers (VGCF) have an average diameter of 200 nm and lengths from several microns to over 10 mm. During sample production (mixing and sonication; as described above) these fibers broke down to lengths below 100 microns. The thermal conductivity of these fibers was 1900 W/m-K at room temperature.

Results

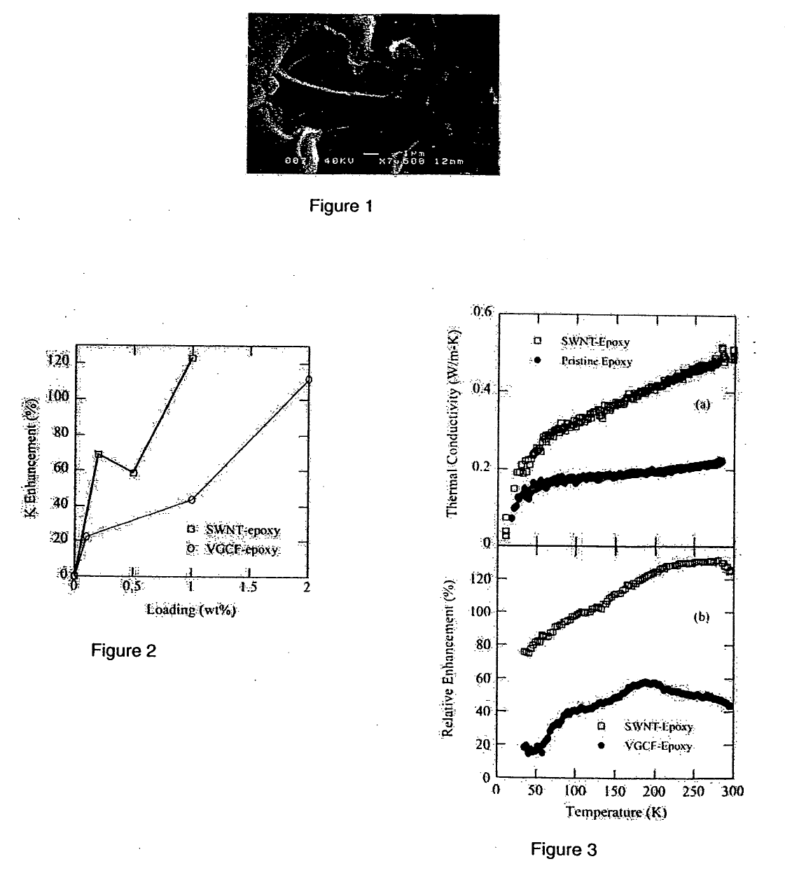

The homogeneity of the SWNTs dispersion in the epoxy material is characterized as random tube orientation. A scanning electron micrograph of a 1 wt % SWNT-epoxy composite is shown in FIG. 1. On the micrometer scale shown in FIG. 1, randomly oriented nanotube bundles are visible throughout the matrix.

From the bulk product of the materials described above, samples were cut, typically 1 mm×1 mm×2 mm, taking care to exclude regions with macroscopic air inclusions. Testing verified that various samples cut from the same composite material yielded identical results for all measurements set forth below.

Thermal Conductivity

Thermal conductivity was measured from 20-300 K with a comparative technique described in detail by Kim et al., Condensed Matter, 0106578, 2001, herein incorporated in its entirety by reference. This comparative method includes mounting a sample between two constant rods of known thermal conductivity, and passing a heat current through the thermal circuit to a thermal ground (the sample stage). Drops in temperature are measured across each rod and the sample with differential thermocouples, thus providing the relative thermal conductivity of the sample. The second standard is used to monitor heat current loss due to radiation and other sources, with care taken to minimize these negative effects. In calibration runs, this method accurately reproduced the known thermal conductivity of numerous different samples of metals and carbon fibers. Results from 5-10 measurements were averaged for each sample to obtain the thermal conductivity data as a function of carbon loading. These data are plotted in the graphs shown in FIGS. 2 and 3.

FIG. 2 shows the percent thermal conductivity enhancement (k) as a function of percent weight loading of carbon material for both the SWNT composite materials, and the vapor grown carbon fiber (VGCF) composite materials. Thermal conductivity enhancement increased monotonically with SWNT loading from 0.2 W/m-K for pristine epoxy to 0.5 W/m-K at 2 wt % SWNT loading.

The thermal conductivity enhancement in SWNT-epoxy samples rises much more rapidly than in samples loaded with VGCF. A 125% thermal conductivity enhancement was observed at 1 wt % SWNT loading, while 1 wt % loading of VGCF produced a 45% increase in thermal conductivity. Samples loaded with 1 wt % unpurified SWNT material showed a 70% increase in thermal conductivity at 40K, rising to 125% at room temperature; the enhancement due to 1 wt % loading of VGCF is three times smaller.

The data presented in FIG. 3 were collected in a closed-cycle helium-cooled system. The typical raw data for SWNT composite and pristine epoxy materials and the enhancement in thermal conductivity of the SWNT composites and the VGCF composites are shown graphically in FIG. 3 as a function of temperature. The SWNT-epoxy samples of FIG. 3 were loaded with 1 wt % SWNT. Thermal conductivity enhancement was observed at all temperatures between 10 K and 300 K for SWNT-epoxy composites over pristine epoxy and VGCF-epoxy composites. The SWNT-composite showed a markedly higher thermal conductivity enhancement at all temperatures than VGCF-loaded samples. Also, the raw thermal conductivity measurements illustrate that the SWNT composite material had greater thermal conductivity at all temperatures from 0-300 K than the pristine epoxy material.

Electrical Conductivity

Electrical conductivity of the composite materials was also measured to characterize the extent of the carbon material network. For both the SWNTs and the VGCFs, low-loading samples displayed only a factor of 2 or 3 increase in conductivity, with higher-loading samples showing a sudden jump of more than 10⁴. These data are consistent with the formation of a percolating network forming through the sample at higher loading. The loading at the percolation threshold, where the sharp onset in conductivity is observed, is between 0.1 and 0.2 wt % for SWNT composite materials, while the VGCF composite materials required loading between 1 and 2 wt % to achieve the percolation threshold. The SWNTs in composite materials of the invention are randomly oriented, therefore the percolation network forms at lower loading than previously reported.

Mechanical Properties

Resistance to plastic flow for SWNT-epoxy samples was measured using a Tukon Microhardness Tester with a Vickers indenter. Epoxy samples were mechanically polished to ensure a smooth sample surface, and Vickers Hardness (VH) was measured using a 100 gram load. The VH increased almost linearly from 0.4 for the pristine epoxy to 1.4 at 2 wt % SWNT loading. A monotonic increase in VH with SWNT loading was observed with a factor of 3.5 increase at 2 wt %. These VH data suggest that SWNT composites do not suffer mechanical strength degradation, and the increase in VH suggests that NTs may enhance the strength of composite materials. An increase in VH reflects an enhancement of both the bulk modulus of the material and the yield strength of the material.

These data illustrate that a small fraction of SWNT material dramatically enhances the thermal properties of an epoxy matrix, and that SWNTs are more effective than larger diameter carbon materials for this purpose. The nanoscale diameter and larger aspect ratio of NTs enable a more extensive network to form at the same weight loading, as indicated by the lower critical loading for percolation seen in the electrical conductivity measurements.

A novel method for incorporating nanostructures in polymeric materials to form composites with enhanced mechanical, thermal and electrical properties than previously achieved is provided. The solvation or suspension of nanostructures and polymeric material in a solvent or suspension medium provides uniform dispersion and results in composites that display such enhanced properties.

We claim:

1. A composition comprising a highly dispersed mixture of a polymeric material and nanostructures in a liquid medium wherein the nanostructures comprise from about 0.01 to about 50.0 percent by weight of the solids in the mixture and are dispersed throughout the mixture.

2. The composition of claim 1 wherein the polymeric material is selected from the group consisting of polyesters, polyolefins, vinyl polymers, epoxies, polyamides, polyethylene, polystyrene, poly(methyl methacrylate), polypropylene sulfide, polypropylene oxide, bisphenol F, silicone, thermoplastics, thermosetting materials and elastomers, and the nanostructures have an average size between about 0.5 and about 50 nm in diameter and between about 0.5 nm and about 10 microns in length.

3. The composition of claim 1 in the form of a solution.

4. The composition of claim 1 in the form of a suspension.

5. The composition of claim 1 wherein the polymeric material and the nanostructures are dispersed in the liquid medium by sonication applied for a period of about 1 hour to about 36 hours.

6. The composition of claim 1 wherein the mixture is degassed under reduced air pressure.

7. A polymer composite comprising the highly dispersed mixture of the polymeric material and the nanostructures of claim 1 wherein the liquid medium is substantially removed therefrom.

8. The composite of claim 7 wherein the liquid medium is removed by evaporation.

9. The composite of claim 7 wherein the mixture is cured.

10. The composite of claim 9 wherein the mixture is cured by the addition of a curing agent.

11. A polymer composite kit comprising a first amount of the composite of claim 7 and a second amount of a curing agent sufficient to cure the first amount of the composite upon combination therewith.

12. A method for making a composition comprising the step of combining a polymeric material and nanostructures in a liquid medium to form a highly dispersed mixture wherein the nanostructures comprise from about 0.01 to about 50.0 percent by weight of the total solids of the mixture.

13. The method of claim 12 wherein the polymeric material is selected from the group consisting of polyesters, polyolefins, vinyl polymers, epoxies, polyamides, polyethylene, polystyrene, poly(methyl methacrylate), polypropylene sulfide, polypropylene oxide, bisphenol F, silicone, thermoplastics, thermosetting materials and elastomers, and the nanostructures have an average size between about 0.5 and about 50 nm in diameter and between about 0.5 nm and about 10 microns in length.

14. The method of claim 12 wherein the dispersion is accomplished by sonication.

15. The method of claim 12 further comprising the step of degassing the mixture under reduced air pressure.

16. The method of claim 12 further comprising the step of separating the highly dispersed mixture of the polymeric material and the nanostructures from the liquid medium.

17. The method of claim 16 wherein the separation step is accomplished by evaporation.

18. The method of claim 16 further comprising the step of curing the polymeric material.

19. The method of claim 18 wherein the curing step comprises adding a curing agent to the polymeric material.
